(19) United States
(12) Patent Application Publication
(10) Pub. No.: US 2025/0156354 A1
(43) Pub. Date: May 15, 2025

(54) INTELLIGENT MOVEMENT OF EXTERNAL CONTENT TO INTERNAL MEMORY

(71) Applicant: Texas Instruments Incorporated, Dallas, TX (US)

(72) Inventors: Mihir Narendra Mody, Bengaluru (IN); Prithvi Shankar Yeyyadi Anantha, Bangalore (IN); Sriramakrishnan Arumbuliyur Govindarajan, Bangalore (IN); Sai Karthik Rajaraman, Frisco, TX (US); Pratheesh Gangadhar Thalakkal Kottila Veedu, Bangalore (IN); Niraj Nandan, Plano, TX (US); Mel Alan Phipps, Sugar Land, TX (US)

(21) Appl. No.: 18/933,348

(22) Filed: Oct. 31, 2024

Related U.S. Application Data
(60) Provisional application No. 63/597,464, filed on Nov. 9, 2023.

(51) Int. Cl. G06F 13/28

(52) U.S. Cl. CPC G06F 13/28; G06F 2213/28

(57) ABSTRACT

An example accelerator circuit includes a direct memory access (DMA) circuit configured to copy contents of an off-chip memory to an internal memory of a device. In some examples, the off-chip memory is external to the device. The example accelerator circuit also includes a decoder circuit configured to determine a transaction from a processor circuit of the device is associated with a memory address included in a region of the off-chip memory to be copied to the internal memory. In some examples, the decoder circuit is also configured to direct the transaction to one of the off-chip memory or the internal memory based on whether a DMA copy of the region of the off-chip memory to the internal memory has completed.

### CROSS-REFERENCE TO RELATED APPLICATION

This patent application claims the benefit of and priority to U.S. Provisional Patent Application No. 63/597,464, filed Nov. 9, 2023, which application is hereby incorporated herein by reference in its entirety.

### TECHNICAL FIELD

This description relates generally to accessing memory and, more particularly, to intelligent movement of content, such as external content, to internal memory.

### BACKGROUND

Some silicon on chip (SoC) devices, such as some microcontroller units (MCUs) microprocessor units (MPUs), include internal Flash memory that can be programmed with content associated with one or more applications to be executed by the SoC device. The content may be code (e.g., instructions, program code, etc.) to be executed by the SoC device to implement the application(s), data to be processed by the application(s), etc. However, some other SoC devices, such as some high performance MCUs and MPUs, do not include such internal Flash memory. SoC devices (e.g., MCUs, MPUs, etc.) that do not include internal Flash memory may rely on off-chip memory to store the content (e.g., code, data, etc.) for application(s) to be executed by those SoC devices.

### SUMMARY

For methods and apparatus to perform intelligent movement of external content to internal memory, an example accelerator circuit includes a direct memory access (DMA) circuit configured to copy contents of an off-chip memory to an internal memory of a device. In some examples, the off-chip memory is external to the device. The example accelerator circuit also includes a decoder circuit configured to determine a transaction from a processor circuit of the device is associated with a memory address included in a region of the off-chip memory to be copied to the internal memory. In some examples, the decoder circuit is also configured to direct the transaction to one of the off-chip memory or the internal memory based on whether a DMA copy of the region of the off-chip memory to the internal memory has completed.

For methods and apparatus to perform intelligent movement of external content to internal memory, an example device includes internal memory, a processor circuit, and an accelerator circuit configured to initiate a copy of a region of an off-chip memory to the internal memory based on configuration information provided by at least one of a bootloader or an application. In some examples, the bootloader stored in the off-chip memory. In some examples, the accelerator circuit is configured to determine a transaction from the processor circuit is associated with a memory address included in the region of the off-chip memory, and direct the transaction to one of the off-chip memory or the internal memory based on whether the copy of the region of the off-chip memory to the internal memory has completed.

For methods and apparatus to perform intelligent movement of external content to internal memory, as example system includes random access memory, a processor circuit, off-chip memory external to the processor circuit, and an accelerator circuit configured to copy one or more regions of the off-chip memory to the random access memory based on configuration information provided by at least one of a bootloader or an application. In some examples, the accelerator circuit is configured to determine a transaction from the processor circuit is associated with a memory address included in a first one of the regions of the off-chip memory to be copied to the random access memory. In some examples, the accelerator circuit is configured to direct the transaction to one of the off-chip memory or the random access memory based on whether the copy of the first one of the regions of the off-chip memory to the random access memory has completed.

### BRIEF DESCRIPTION OF THE DRAWINGS

FIG. 1 is a block diagram of an example system including a first example microcontroller unit configured to access code and data from off-chip memory.

FIG. 2 is a block diagram of an example system including a second example microcontroller unit including one or more example mirror accelerator circuits configured to perform intelligent movement of external content (e.g., code and data) from off-chip memory to internal memory.

FIG. 3 illustrates example operation of one of the mirror accelerator circuits of FIG. 2.

FIG. 4 is a block diagram of an example implementation of one of the mirror accelerator circuits of FIG. 2.

FIG. 5 is a flowchart representative of an example mirroring procedure implemented by one of the mirror accelerator circuits of FIG. 2.

FIGS. 6-8 are flowcharts representative of example machine-readable instructions or example operations that may be at least one of executed, instantiated, or performed by programmable circuitry to implement example software tools (e.g., an example software compiler, an example software linker, etc.) that generate configuration information to be used by the example mirror accelerator circuits of FIGS. 2-5 to perform intelligent movement of content (e.g., code and data), which may be external or internal, to internal memory.

FIGS. 9-10 illustrate example performance results capable of being achieved by the mirror accelerator circuit(s) included in the example microcontroller unit of FIG. 2.

FIG. 11 is a block diagram of an example processing platform including programmable circuitry structured to execute, instantiate, or perform the example machine-readable instructions or perform the example operations of FIGS. 6-8 to implement the example software tools disclosed herein.

FIG. 12 is a block diagram of an example software/firmware/instructions distribution platform (e.g., one or more servers) to distribute software, instructions, or firmware (e.g., corresponding to the example machine-readable instructions of FIGS. 6-8) to client devices associated with end users or consumers (e.g., for license, sale, or use), retailers (e.g., for sale, re-sale, license, or sub-license), or original equipment manufacturers (OEMs) (e.g., for inclusion in products to be distributed to, for example, retailers or to other end users such as direct buy customers).

The drawings are not necessarily to scale. Generally, the same reference numbers in the drawing(s) and this description refer to the same or similar (functionally and/or structurally) features and/or parts. Although the drawings show regions with clean lines and boundaries, some or all of these lines and boundaries may be idealized. In reality, the boundaries or lines may be unobservable, blended or irregular.

### DETAILED DESCRIPTION

As noted above, some MCUs include internal Flash memory that can be programmed with content associated with one or more applications to be executed by the MCU. High performance MCUs are a new class of SoCs that employ higher process nodes and higher performance central processing unit (CPU) cores than MCUs that include internal Flash memory. For example, such high performance MCUs may employ 16 nanometer (nm), 14 nm and/or even 10 nm process nodes with multi-core (e.g., quad-core) architectures that support operation at 400 Megahertz (MHz) to 1 Gigahertz (GHz) or more. However, migration of Flash memory to such process nodes may be difficult or unavailable for at least some high performance MCUs. As a result, high performance MCUs may rely on external Flash memory, such as off-chip Flash memory or separate on-die Flash memory include in, for example, a system-in-a-chip package (SIP), as well as associated interface technologies, such as octal serial peripheral interface (OSPI), expanded serial peripheral interface (xSPI), etc., to store programmable content (e.g., code, data, etc.) for application(s) to be executed by the MCU. Some such MCUs may access/execute the content (or some portion(s) thereof) directly from the off-chip memory, or copy the contents (or some portion(s) thereof) from the off-chip memory to internal memory of the SoC devices before accessing/executing the content (or the portion(s) thereof). However, external Flash technologies may be 4 to 8 times slower than internal Flash technologies due to limited bus width (e.g., 8 bits) and clock rate (e.g., 166 MHz).

Accordingly, the use of external Flash memory may place one or more constraints on a system design employing high performance MCUs. For example, code execution from external Flash using execute-in-place (XIP) may be 4 to 8 times slower as compared to execution from internal Flash memory. Also, code execution from internal memory, such as internal random access memory (RAM) of the MCU, is comparable to execution from internal Flash memory. However, execution from internal memory increases boot time due to the time incurred for copying the contents from the external Flash memory to the internal memory, which is referred to as image downloading, yielding boot time in excess of 75 milliseconds (ms) in some examples. However, some MCU system designs have a goal of achieving <30 ms boot time with a 16 MB internal Flash size.

As mentioned above, XIP is one approach used by MCUs that rely on external Flash memory to store content for application(s) to be executed by the MCU. In some such approaches, when the MCU is booted, the MCU configures the external Flash memory in XIP mode. The MCU then copies the data associated with an application to internal memory (e.g., internal RAM), but leaves the application program code in the external Flash memory. The MCU then executes the program code in-place from the external Flash memory. This approach yields a relatively faster boot time as compared to image download approaches, such as a boot time of <60 ms, in some examples. However, program execution speed from external Flash memory is slower as compared to internal memory, such as 4.5 times slower, in some examples.

As also mentioned above, image download is another approach used by MCUs that rely on external Flash memory to store content for application(s) to be executed by the MCU. In some such approaches, when the MCU is booted, the MCU causes the complete application contents (e.g., program code, read-only data, read/write data, etc., collectively referred to as the application's image) to be copied from the external Flash memory to the internal memory (e.g., RAM) of the MCU. After the image copy (also referred to as image download) is complete, the MCU then executes the program code from the internal memory (e.g., RAM). This approach yields application execution speed from internal memory that is comparable to execution from internal Flash memory. However, application boot time is slow relative to execution from internal Flash memory due to the time spent waiting for the image copy from external Flash memory to internal memory (e.g., RAM) to complete, which may be up to 80 ms, in some examples.

In contrast with the foregoing approaches, disclosed techniques perform intelligent movement of application content from off-chip memory to internal memory that enables execution from internal memory (e.g., internal RAM) using dynamic content loading from external Flash memory while achieving startup goals comparable to execution from internal Flash memory, which may be <30 ms, in some examples. Some such disclosed techniques, also referred to as intelligent external content mirroring techniques, are based on an example mirror accelerator circuit that intelligently mirrors content from external (e.g., off-chip) memory to internal memory for access by a central processing unit (CPU) of the MCU. In some disclosed examples, a bootloader configures the mirror accelerator circuit (e.g., also referred to as a mirror accelerator, a fast local copy (FLC) accelerator circuit, an FLC accelerator, etc.) during bootup to initiate (e.g., trigger) an external content mirror operation using direct memory access (DMA) to mirror, or copy, contents for an application from the external (e.g., off-chip) memory to the internal memory of the MCU. The CPU is then reset and starts application execution without waiting for the mirror operation to complete. While the external content mirror operation is in progress, the mirror accelerator checks memory transactions from the CPU and passes those transactions associated with completed content mirroring to the internal memory (e.g., internal RAM). However, for transactions associated with content for which content mirroring is still in progress, the mirror accelerator redirects those transactions to the external memory (e.g., off-chip Flash memory). In some examples, the mirror accelerator also performs address translation when redirecting CPU transactions to the external memory. In some examples, on-the-fly authentication and/or error correction coding (ECC) features of an available memory controller (e.g., a Flash controller) are used by the DMA for secure and safe copy of data from external (e.g., off-chip) memory.

Intelligent external content mirroring techniques disclosed herein can provide one or more advantages over other approaches. In some examples, disclosed intelligent external content mirroring techniques can achieve almost instantaneous CPU startup, such as <1 ms setup time, in some examples. Also, intelligent external content mirroring, as disclosed herein, can be transparent to the application being booted and executed, and the application can be developed and debugged assuming the application's code and data reside in internal memory (e.g., internal RAM). Some intelligent external content mirroring techniques disclosed herein employ a smart layout algorithm to increase the likelihood of CPU transactions being associated with completed mirroring operations such that the internal memory “hit” ratio is high. For example, to help ensure application content (e.g., code and data) is mirrored (e.g., copied) from external (e.g., off-chip) memory to internal memory (e.g., RAM) before it is accessed by the CPU, some disclosed intelligent external content mirroring techniques include software tools (e.g., compilers, linkers, etc.) that result in a program code layout in memory that is ordered based on the order of function call execution during application code start-up. For example, such software tools (e.g., compilers, linkers, etc.) can implement a smart layout algorithm using static call graph and dynamic code coverage to arrange the program code in function call order, thereby improving the internal memory “hit” ratio by causing content mirroring to follow the function call order of the program code.

Although intelligent external content mirroring is described herein in the context of external (e.g., off-chip) Flash memory, such intelligent external content mirroring techniques can be employed with any types and/or numbers of external (e.g., off-chip) memory, storage, etc. Intelligent external content mirroring can also be adapted for use in mirroring content from a first internal memory (e.g., a slower internal memory) to a second internal memory (e.g., a faster internal memory). Also, although intelligent external content mirroring is described herein in the context of implementation in MCUs, such intelligent external content mirroring techniques can be implemented in any type of system, device, SoC, integrated circuit, etc., such as MCUs, MPUs, etc.

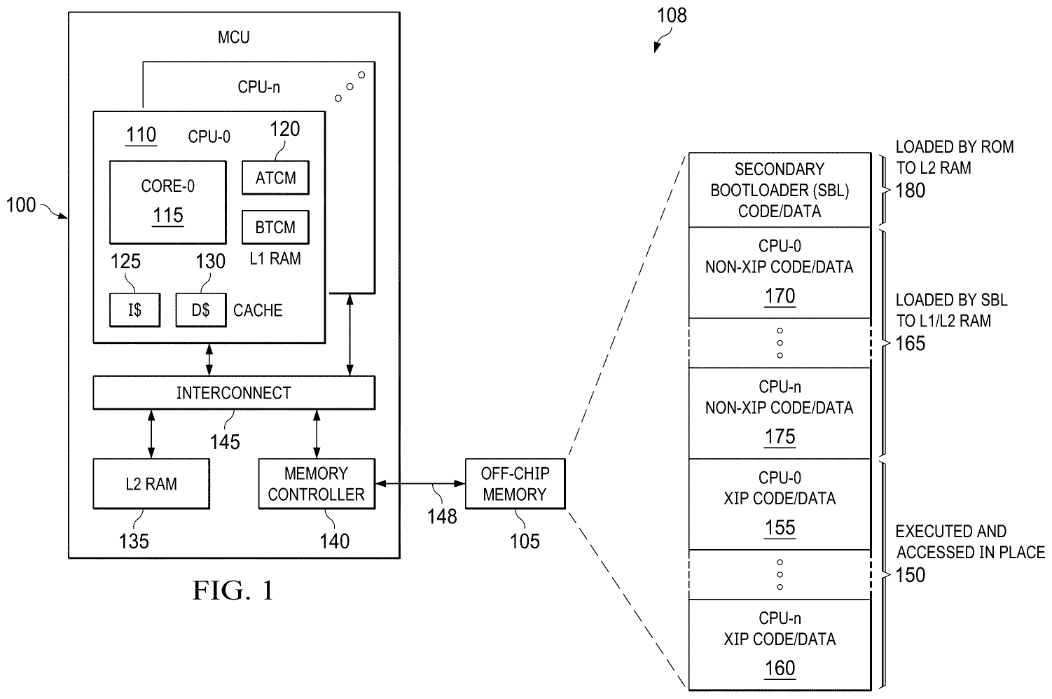

Turning to the figures, a block diagram of a first example MCU 100 configured to access code and data from example off-chip memory 105 is illustrated in FIG. 1. Although the processing device shown in FIG. 1 is described as MCU 100, the elements shown within MCU 100 can also be implemented in any processing system or device, such as an MPU system. The MCU 100 and the off-chip memory 105 can be included in an example device or system 108, which can be any compute device, system, component, etc. The MCU 100 includes one or more example CPUs 110. In the illustrated example, a given CPU 110 of the MCU 100 includes an example processor core 115, example local internal memory 120, example instruction cache 125 and example data cache 130. Although the CPU 110 is illustrated as including a single processor core 115, in some examples, the CPU 110 can include any number of processor cores. Also, the local internal memory 120, also referred to as the local memory 120, can be implemented by any number and/or type(s) of memories, such as level 1 (L1) RAM in the illustrated example. In the illustrated example, the local memory 120 is implemented by one or more tightly coupled memories (TCMs), labeled “ATCM” and “BTCM” in FIG. 1.

The example MCU 100 of FIG. 1 also includes example shared internal memory 135, example memory controller circuitry 140, and example interconnect circuitry 145. The shared internal memory 135, also referred to as the shared memory 135, can be implemented by any number and/or type(s) of memories, such as level 2 (L2) RAM in the illustrated example. The memory controller circuitry 140, also referred to as the memory controller 140, can be implemented by any number and/or type(s) of memory controller circuits configured to interface with any number and/or type(s) of off-chip memory 105. For example, the memory controller circuitry 140 can implement an example serial peripheral interface 148, such as an OSPI, and xSPI, etc., to interface with the off-chip memory 105. In some examples, the memory controller circuitry 140 also implements authentication and/or ECC functions for accessing the contents (e.g., code, data, etc.) of the off-chip memory 105.

In the example MCU 100, the interconnect circuitry 145 couples the CPU(s) 110 with the shared internal memory 135 and the memory controller circuitry 140. The interconnect circuitry 145 can be implemented by any number and/or type(s) of interconnection technologies, such as one or more busses, one or more registers, one or more memories, one or more switching fabrics, etc. As such, the interconnect circuitry 145 enables the one or more CPUs 110 to access the shared internal memory 135 and the off-chip memory 105 via the memory controller 140. Also, in some examples, the interconnect circuitry 145 enables the memory controller 140 to access the shared internal memory 135 and the respective local internal memory 120 of the one or more CPUs 110.

The off-chip memory 105 of the illustrated example can be implemented by any number(s) and/or type(s) of memories, storage devices, etc. For example, the off-chip memory 105 can be implemented by and/or include one or more external Flash memories, one or more external RAMs, one or more external ROMs, etc. In the illustrated example, the off-chip memory 105 is configured to store content (e.g., code, data, etc.) associated with one or more applications to be executed by respective ones of the one or more CPUs 110 of the MCU 100.

Furthermore, the MCU 100 of the illustrated example is configured to implement one or more of the XIP approach and the image download approach described above for accessing the content stored on the off-chip memory 105. As such, the off-chip memory 105 includes a first example content region 150 to store content (e.g., code, data, etc.) associated with applications that are to be executed from the off-chip memory 105. For example, the off-chip memory 105 includes an example content region 155 to store such XIP content associated with one or more applications to be executed by a first one of the CPUs 110 (labeled “CPU-0” in FIG. 1), an example content region 160 to store such XIP content associated with one or more applications to be executed by a second one of the CPUs 110 (labeled “CPU-n” in FIG. 1), etc. The off-chip memory 105 of the illustrated example also includes a second example content region 165 to store content (e.g., code, data, etc.) associated with application(s) for which their images are to be downloaded to and executed from internal memory, such as the local memory 120 and/or the shared memory 135. For example, the off-chip memory 105 includes an example content region 170 to store such non-XIP content associated with one or more applications to be executed by the first one of the CPUs 110 (labeled “CPU-0” in FIG. 1), an example content region 175 to store such non-XIP content associated with one or more applications to be executed by the second one of the CPUs 110 (labeled “CPU-n” in FIG. 1), etc.

In the illustrated example, the off-chip memory 105 also stores an example secondary bootloader 180 to implement the XIP and image downloading approaches for accessing the contents of the off-chip memory 105. In some examples, the secondary bootloader 180 is invoked by a primary bootloader of MCU 100 upon power-up of the MCU 100. In some examples, to implement the XIP approach for accessing the XIP content 150 of the off-chip memory 105, the secondary bootloader 180 configures the CPUs 110 and/or the memory controller 140 to copy the data from the respective XIP content regions 155-160 of the off-chip memory 105 to the shared memory 135 and/or the respective local memory 120 of the CPUs 110. The secondary bootloader 180 then configures the CPUs 110 to execute the program code in-place from the respective XIP content regions 155-160 of the off-chip memory 105.

In some examples, to implement the image download approach for accessing the non-XIP content 165 of the off-chip memory 105, the secondary bootloader 180 configures the CPUs 110 and/or the memory controller 140 to copy the application images (e.g., code and data) from the respective non-XIP content regions 170-175 of the off-chip memory 105 to the shared memory 135 and/or the respective local memory 120 of the CPUs 110. The secondary bootloader 180 also configures the CPUs 110 to execute the program code from the shared memory 135 and/or the respective local memory 120 of the CPUs 110 after the image copying is complete.

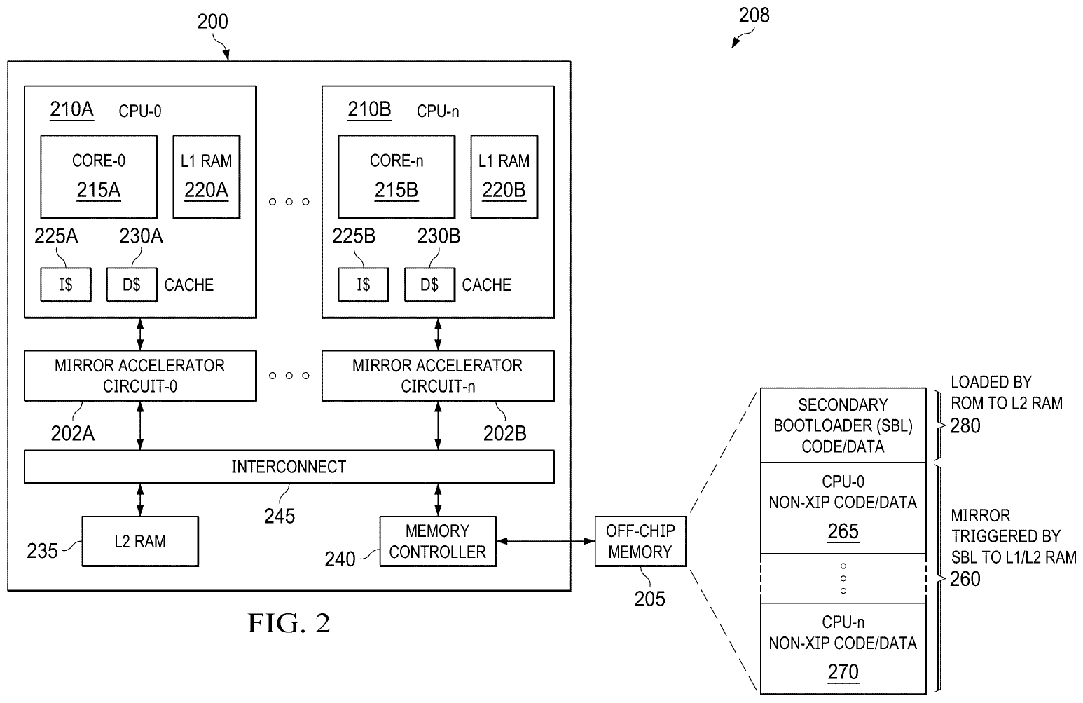

A block diagram of a second example MCU 200 including one or more example mirror accelerator circuits 202 configured to perform intelligent movement of external content (e.g., code and data) from example off-chip memory 205 to internal memory is illustrated in FIG. 2. The MCU 200 and the off-chip memory 205 can be included in an example device or system 208, which can be any compute device, system, component, etc. The MCU 200 includes one or more example CPUs 210 which may be implemented as by respective processor circuits. For example, the MCU 200 includes an example CPU 210A and an example CPU 210B. In the illustrated example, the CPU 210A of the MCU 200 includes an example processor core 215A, example local internal memory 220A, example instruction cache 225A and example data cache 230A. The processor core 215A can be implemented by any number(s) and/or type(s) of processor circuits. Although the CPU 210A is illustrated as including a single processor core 215A, in some examples, the CPU 210A can include any number of processor cores. Also, the local internal memory 220A, also referred to as the local memory 220A, can be implemented by any number and/or type(s) of memories, such as L1 RAM in the illustrated example. In some examples, the local memory 220A is implemented by one or more TCMs.

Similarly, in the illustrated example, the CPU 210B of the MCU 200 includes an example processor core 215B, example local internal memory 220B, example instruction cache 225B and example data cache 230B. The processor core 215B can be implemented by any number(s) and/or type(s) of processor circuits. Although the CPU 210B is illustrated as including a single processor core 215B, in some examples, the CPU 210B can include any number of processor cores. Also, the local internal memory 220B, also referred to as the local memory 220B, can be implemented by any number and/or type(s) of memories, such as L1 RAM in the illustrated example. In some examples, the local memory 220B is implemented by one or more TCMs. In the following description, the CPU 210A and the CPU 210B are referred to collectively as the CPU(s) 210, the processor core 215A and the processor core 215B are referred to collectively as the processor core(s) 215, the local internal memory 220A and the local internal memory 220B are referred to collectively as the local internal memory 220, the instruction cache 225A and the instruction cache 225B are referred to collectively as the instruction cache(s) 225, and the data cache 230A and the data cache 230B are referred to collectively as the data cache(s) 230.

The example MCU 200 of FIG. 2 also includes example shared internal memory 235, example memory controller circuitry 240, and example interconnect circuitry 245. The shared internal memory 235, also referred to as the shared memory 235, can be implemented by any number and/or type(s) of memories, such as L2 RAM in the illustrated example. The memory controller circuitry 240, also referred to as the memory controller 240, can be implemented by any number and/or type(s) of memory controller circuits configured to interface with any number and/or type(s) of off-chip memory 205. For example, the memory controller circuitry 240 can implement an example serial peripheral interface 248, such as an OSPI, and xSPI, etc., to interface with the off-chip memory 205. In some examples, the memory controller circuitry 240 also implements authentication and/or ECC functions for accessing the contents (e.g., code, data, etc.) of the off-chip memory 205.

In the example MCU 200, the interconnect circuitry 245 couples the mirror accelerator circuits 202 with the shared internal memory 235 and the memory controller circuitry 240. The interconnect circuitry 245 can be implemented by any number and/or type(s) of interconnection technologies, such as one or more busses, one or more registers, one or more memories, one or more switching fabrics, etc. As such, the interconnect circuitry 245 enables the CPUs 210 to access the shared internal memory 235 and the off-chip memory 205 via mirror accelerator circuits 202 and the memory controller 240. Also, in some examples, the interconnect circuitry 245 enables the memory controller 240 to access the shared internal memory 235 and the respective local internal memory 220 of the CPUs 210.

The off-chip memory 205 of the illustrated example can be implemented by any number(s) and/or type(s) of memories, storage devices, etc. For example, the off-chip memory 205 can be implemented by and/or include one or more external Flash memories, one or more external RAMs, one or more external ROMs, etc. In the illustrated example, the off-chip memory 205 is configured to store content (e.g., code, data, etc.) associated with one or more applications to be executed by respective ones of the CPUs 210 of the MCU 200.

Furthermore, the MCU 200 of the illustrated example is configured to implement intelligent external content mirroring of the content stored on the off-chip memory 205. As such, the off-chip memory 205 includes an example content region 265 to store application content (e.g., code, data, etc.) to be mirrored to internal memory, such as the local memory 120 and/or the shared memory 135. For example, the off-chip memory 205 includes an example content region 270 to store such non-XIP content associated with one or more applications to be executed by the first CPU 210A, an example content region 275 to store such non-XIP content associated with one or more applications to be executed by the second CPU 210B, etc.

As mentioned above, the MCU 200 includes the mirror accelerator circuits 202 to perform intelligent movement of external content (e.g., code and data) from the off-chip memory 205 to internal memory, such as the shared memory 235 and/or the local memory 220. In the illustrated example, the CPUs 210 are associated with (e.g., coupled to) respective mirror accelerator circuits 202. For example, the mirror accelerator circuits 202 include an example mirror accelerator circuit 202A associated with (e.g., coupled to) the CPU 210A and an example mirror accelerator circuit 202B associated with (e.g., coupled to) the CPU 210B. The mirror accelerator circuit 202A and the mirror accelerator circuit 202B are referred to collectively as the mirror accelerator circuits 202.

In the illustrated example, the off-chip memory 205 also stores an example secondary bootloader 280 to configure the mirror accelerator circuits 202 to mirror the external content (e.g., code and data) from the off-chip memory 205 to internal memory, such as the shared memory 235 and/or the local memory 220. In some examples, the secondary bootloader 280 is invoked by a primary bootloader of MCU 200 upon power-up of the MCU 200. In some examples, the secondary bootloader 280 configures the mirror accelerator circuits 202 with configuration information specifying the regions of the off-chip memory 205 containing content for the CPUs 210 associated with the respective mirror accelerator circuits 202. For example, the secondary bootloader 280 may configure the mirror accelerator circuit 202A with configuration information that specifies the starting address, size, etc., of the content region 270 associated with the CPU 210A coupled to the mirror accelerator circuit 202A. In some examples, the off-chip memory 205 may include multiple regions containing content associated with applications to be executed by the CPU 210A. In such examples, the secondary bootloader 280 may configure the mirror accelerator circuit 202A with configuration information that specifies the starting addresses, sizes, etc., of the different content regions of the off-chip memory 205 that are associated with the CPU 210A. Likewise, the secondary bootloader 280 may configure the mirror accelerator circuit 202B with configuration information that specifies the starting address, size, etc., of the content region 275 associated with the CPU 210B coupled to the mirror accelerator circuit 202B. In some examples, the off-chip memory 205 may include multiple regions containing content associated with applications to be executed by the CPU 210B. In such examples, the secondary bootloader 280 may configure the mirror accelerator circuit 202B with configuration information that specifies the starting addresses, sizes, etc., of the different content regions of the off-chip memory 205 that are associated with the CPU 210B.

In some examples, the configuration information provided by the secondary bootloader 280 to the mirror accelerator circuits 202 also specifies the target addresses of mirrored content in the shared memory 235 and/or the local memory 220. For example, the configuration information provided by the secondary bootloader 280 to the mirror accelerator circuit 202A may specify the target address, etc., of the shared memory 235 or the local memory 220A to which the content region 270 associated with the CPU 210A is to be mirrored by mirror accelerator circuit 202A. In examples in which the off-chip memory 205 includes multiple regions containing content associated with application to be executed by the CPU 210A, the configuration information provided by the secondary bootloader 280 to the mirror accelerator circuit 202A may specify the different target addresses, etc., of the shared memory 235 and/or the local memory 220A to which those different regions of the off-chip memory 205 are to be mirrored. Likewise, the configuration information provided by the secondary bootloader 280 to the mirror accelerator circuit 202B may specify the target address, etc., of the shared memory 235 or the local memory 220B to which the content region 275 associated with the CPU 210A is to be mirrored by mirror accelerator circuit 202A. In examples in which the off-chip memory 205 includes multiple regions containing content associated with application to be executed by the CPU 210B, the configuration information provided by the secondary bootloader 280 to the mirror accelerator circuit 202B may specify the different target addresses, etc., of the shared memory 235 and/or the local memory 220B to which those different regions of the off-chip memory 205 are to be mirrored.

In the preceding example, the secondary bootloader 280 was responsible for providing the configuration information to the mirror accelerator circuits 202 to configure the mirror accelerator circuits 202 to mirror the external content (e.g., code and data) from the off-chip memory 205 to internal memory, such as the shared memory 235 and/or the local memory 220. However, in some examples, one or more applications executed by the CPUs 210 may be responsible for providing the configuration information to one or more of the mirror accelerator circuits 202 to configure the one or more of the mirror accelerator circuits 202 to mirror the external content (e.g., code and data) from the off-chip memory 205 to internal memory. In some examples, a combination of the secondary bootloader 280 and one or more applications executed by the CPUs 210 may be responsible for providing the configuration information to one or more of the mirror accelerator circuits 202 to configure the one or more of the mirror accelerator circuits 202 to mirror the external content (e.g., code and data) from the off-chip memory 205 to internal memory.

In some examples, after the mirror accelerator circuits 202 are configured by the secondary bootloader 280, the mirror accelerator circuits 202 begin mirroring the contents of the off-chip memory 205 to the shared memory 235 and/or the local memory 220. Also, the mirror accelerator circuits 202 intelligently direct transactions from the CPUs 210 to the off-chip memory 205 or the internal memory (e.g., the shared memory 235, the local memory 220, etc.) depending on the status of the content mirroring.

For example, the mirror accelerator circuit 202A may be configured to copy one or more regions of the off-chip memory 205 to the shared RAM 220A and/or the local RAM 235 based on configuration information provided by the bootloader 280. The mirror accelerator circuit 202A may then determine a transaction from the CPU 210A (or, more generally, the processor circuit 210A) is associated with a memory address included in a first one of the regions (e.g., the region 265) of the off-chip memory 205 to be copied to the shared RAM 220A and/or the local RAM 235. The mirror accelerator circuit 202A may then direct the transaction to one of the off-chip memory 205 or the shared RAM 220A and/or the local RAM 235 based on whether the copy of the first one of the regions (e.g., the region 265) of the off-chip memory 205 to the shared RAM 220A and/or the local RAM 235 has completed.

Similarly, the mirror accelerator circuit 202B may be configured to copy one or more other regions of the off-chip memory 205 to the shared RAM 220B and/or the local RAM 235 based on configuration information provided by the bootloader 280. The mirror accelerator circuit 202B may then determine a transaction from the CPU 210B (or, more generally, the processor circuit 210B) is associated with a memory address included in a first one of those other regions (e.g., the region 270) of the off-chip memory 205 to be copied to the shared RAM 220B and/or the local RAM 235. The mirror accelerator circuit 202B may then direct the transaction to one of the off-chip memory 205 or the shared RAM 220B and/or the local RAM 235 based on whether the copy of the first one of those other regions (e.g., the region 270) of the off-chip memory 205 to the shared RAM 220B and/or the local RAM 235 has completed.

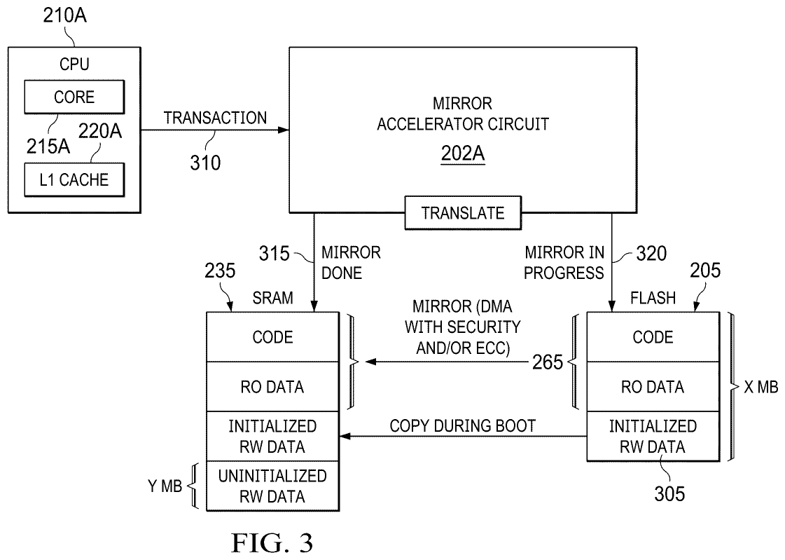

FIG. 3 illustrates further example operation of one of the mirror accelerator circuits 202 of FIG. 2, such as the mirror accelerator circuit 205A. However, any of the mirror accelerator circuits 202 of FIG. 2, such as the mirror accelerator circuit 205B, may perform similar operations. Turning to FIG. 3, the mirror accelerator circuit 202A is configured to copy (or mirror) the region 265 of the off-chip memory 205 to the shared RAM 235 based on configuration information provided by the bootloader 280. In the illustrated example, the bootloader 280 also causes the mirror accelerator circuit 202A or the memory controller circuit 240 of the MCU 200 to copy a region 305 of initialized read/write data associated with the region 265 to the shared RAM 235 during boot of the MCU 200.

After the copy (or mirror) is initiated, the mirror accelerator circuit 202A then determines an example transaction 310 from the CPU 210A (or, more generally, the processor circuit 210A), such as an instruction or data access transaction 310, is associated with a memory address included in the region 265 of the off-chip memory 205 to be copied to the shared RAM 235. The mirror accelerator circuit 202A then directs the transaction 310 to one of the off-chip memory 205 or the shared RAM 220A based on whether the copy of the region 265 of the off-chip memory 205 to the shared RAM 235 has completed.

In the illustrated, the mirror accelerator circuit 205A is configured to direct the transaction 310 to the shared RAM 235 after a determination that the copy of the region 265 of the off-chip memory 205 to the shared RAM 235 has completed (illustrated by the directed line 315 in FIG. 3). However, the mirror accelerator circuit 205A is configured to direct the transaction 310 to the off-chip memory 205 after a determination that the copy of the region 265 of the off-chip memory 205 to the shared RAM 235 has not completed (illustrated by the directed line 320 in FIG. 3). (Note, in some examples, the mirror accelerator circuit 202A is configured to copy the region 265 of the off-chip memory 205 to the local memory 220A of the CPU 210. In such examples, the mirror accelerator circuit 202A directs the transaction 310 to the local memory 220A after a determination that the copy of the region 265 of the off-chip memory 205 to the local memory 220A has completed.)

As shown in the example of FIG. 3, the mirror accelerator circuit 202A may be configured to cause at least one of authentication or error correction to be performed (e.g., by the memory controller circuit 240) on contents of the region 265 of the off-chip memory 205 copied to the shared RAM 235 (or the local RAM 220A). Also, as shown in the example of FIG. 3, the mirror accelerator circuit 202A may be configured to perform an address translation on the transaction 310 before directing the transaction 310 to the off-chip memory 205. However, in some examples, the mirror accelerator circuit 202A may be configured to perform an address translation on the transaction 310 before directing the transaction 310 to the shared RAM 235 (or the local RAM 220A).

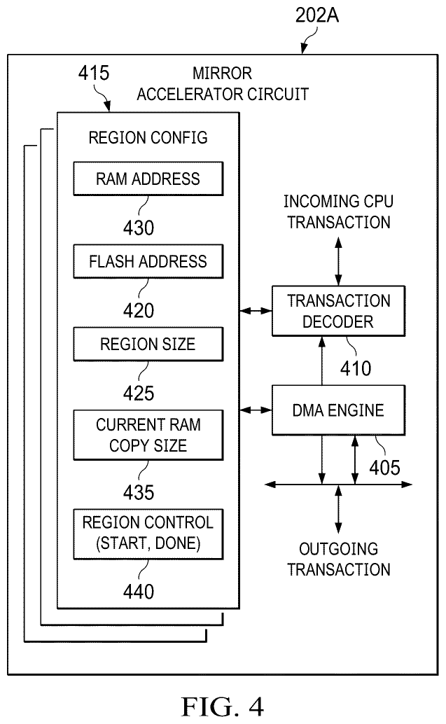

A block diagram of an example implementation of one of the mirror accelerator circuits 202 of FIG. 2, such as the mirror accelerator circuit 202A, is illustrated in FIG. 4. However, any of the mirror accelerator circuits 202 of FIG. 2, such as the mirror accelerator circuit 205B, may be implemented similarly. Turning to FIG. 4, the mirror accelerator circuit 202A of the illustrated example includes an example direct memory access (DMA) circuit 405 configured to copy contents of an off-chip memory, such as the off-chip memory 205, to an internal memory of a device, such as the local RAM 220A and/or the shared RAM 235 of the MCU 200. In some examples, the off-chip memory is external to the device. The mirror accelerator circuit 202A of the illustrated example also includes an example transaction decoder circuit 410 configured to determine a transaction, such as the transaction 310, from a processor circuit of the device, such as the CPU 210A of the MCU 200, is associated with a memory address included in a region, such as the region 265, of the off-chip memory, such as the off-chip memory 205, to be copied to the internal memory, such as the local RAM 220A and/or the shared RAM 235. In the illustrated example, the transaction decoder circuit 410 directs the transaction to one of the off-chip memory or the internal memory based on whether a DMA copy of the region of the off-chip memory to the internal memory has completed.

For example, the transaction decoder circuit 410 directs the transaction to the internal memory (e.g., the local RAM 220A and/or the shared RAM 235) after a determination that the DMA copy of the region 265 of the off-chip memory 205 to the internal memory (e.g., the local RAM 220A and/or the shared RAM 235) has completed. However, the transaction decoder circuit 410 directs the transaction to the off-chip memory 205 after a determination that the DMA copy of the region 265 of the off-chip memory 205 to the internal memory (e.g., the local RAM 220A and/or the shared RAM 235) has not completed. In some examples, the transaction decoder circuit 410 performs an address translation on the transaction before directing the transaction to the internal memory (e.g., the local RAM 220A and/or the shared RAM 235). In some examples, the transaction decoder circuit 410 performs an address translation on the transaction before directing the transaction to the off-chip memory 205.

In the illustrated example, the DMA circuit 405 is configured to copy the region 265 of the off-chip memory 205 to the local RAM 220A and/or the shared RAM 235 based on example configuration information 415 provided by a bootloader, such as the bootloader 280, stored in the off-chip memory 205. In the illustrated example, the configuration information 415 specifies a start address 420 of the region 265 of the off-chip memory 205, at least one of an end address of the region 265 of the off-chip memory 205 or a size 425 of the region 265 of the off-chip memory 205, and a start address 430 of the internal memory (e.g., the local RAM 220A and/or the shared RAM 235) to which the region 265 of the off-chip memory 205 is to be copied (e.g., mirrored). In the illustrated example, the mirror accelerator circuit 202A and. in particular, the DMA circuit 405, updates the configuration information 415 for the region 265 with a current copy size 435 indicating the amount of the region 265 that has been copied (e.g., mirrored) and a region control field 440 to indicate the mirror status of the region 265 (e.g., such as not started, started, complete/done, etc.). In the illustrated example, the mirror accelerator circuit 202A uses the current copy size 435 and/or the region control field 440 to determine how to direct the incoming transaction 310 from the CPU 210A.

In some examples of the mirror accelerator circuit 202A, multiple regions of the off-chip memory 205 are to be copied (e.g., mirrored) to the internal memory (e.g., the local RAM 220A and/or the shared RAM 235). In such examples, the configuration information 415 specifies at least one of (i) respective start addresses and end addresses of the regions of the off-chip memory 205, or (ii) the respective start addresses and respective sizes of the regions of the off-chip memory 205. In some such examples, the configuration information 415 also specifies respective start addresses of the internal memory (e.g., the local RAM 220A and/or the shared RAM 235) to which the multiple regions of the off-chip memory 205 are to be copied (e.g., mirrored). In some examples, execution of the bootloader 280 (e.g., by the CPU 210A) causes the DMA circuit 405 to initiate copying of the regions of the off-chip memory 205 to the internal memory (e.g., the local RAM 220A and/or the shared RAM 235) based on the configuration information 415, and cause the CPU 210A (or, more generally, the processor circuit 210A) to initiate execution of an application associated with the contents of the regions of the off-chip memory 205 before the copying of the regions of the off-chip memory 205 to the internal memory (e.g., the local RAM 220A and/or the shared RAM 235) has completed.

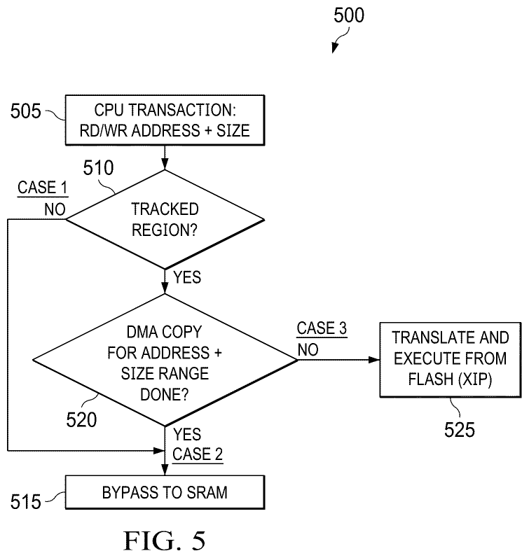

A flowchart representative of an example mirroring procedure 500 implemented by one of the mirror accelerator circuits 202 of FIG. 2, such as the mirror accelerator circuit 205A, is illustrated in FIG. 5. However, any of the mirror accelerator circuits 202 of FIG. 2, such as the mirror accelerator circuit 205B, may perform the example mirroring procedure 500. The procedure 500 begins at block 505 at which the transaction decoder circuit 410 detects a transaction, such as the transaction 310, from the CPU 210A. At block 505, the transaction decoder circuit 410 also determines the memory address and size associated with the detected transaction. At block 510, the transaction decoder circuit 410 evaluates the configuration information 415 stored in the mirror accelerator circuit 205A (e.g., the start address 420 and the size 425) to determine whether the detected transaction is included in a region to be mirrored by the mirror accelerator circuit 205A, which is also referred to as a tracked region. If the detected transaction is not included in a tracked region (corresponding to the “NO” branch from block 510), then at block 515 the transaction decoder circuit 410 directs the transaction to internal memory (e.g., the local RAM 220A and/or the shared RAM 235).

However, if the detected transaction is included in a tracked region (corresponding to the “YES” branch from block 510), then at block 520, transaction decoder circuit 410 evaluates the configuration information 415 (e.g., the current copy size 435 and/or the region control field 440) to determine whether the DMA circuit 405 has completed copying (e.g., mirroring) the tracked region. If the DMA copy (e.g., mirror) of the tracked region is complete (corresponding to the “YES” branch from block 520), then at block 515 the transaction decoder circuit 410 directs the transaction to internal memory (e.g., the local RAM 220A and/or the shared RAM 235). However, if the DMA copy (e.g., mirror) of the tracked region is not complete (corresponding to the “NO” branch from block 520), then at block 525 the transaction decoder circuit 410 directs the transaction to the off-chip memory (e.g., after performing address translation). The example procedure 500 then ends.

Although the examples of FIGS. 2-5 illustrate an MCU 200 including the mirror accelerator circuit(s) 202 to implement intelligent external content mirroring as disclosed herein, the mirror accelerator circuit(s) 202 are not limited thereto. One the contrary, the mirror accelerator circuit(s) 202 can be included in any type of system, device, SoC, integrated circuit, etc., such as MCUs, MPUs, etc.

Some intelligent external content mirroring techniques disclosed herein employ software tools, such as software compilers, linkers, etc., to generate the configuration information to be used by the example mirror accelerator circuit(s) 202 of FIGS. 2-5 to perform intelligent movement of external content (e.g., code and data) from off-chip memory to internal memory. As mentioned above, some such software tools also employ a smart layout algorithm to increase the likelihood of CPU transactions being associated with completed mirroring operations such that the internal memory “hit” ratio is high. For example, to help ensure application content (e.g., code and data) is mirrored (e.g., copied) from external (e.g., off-chip) memory to internal memory (e.g., RAM) before it is accessed by a CPU, at least some software tools (e.g., compilers, linkers, etc.) disclosed herein generate in a program code layout in memory that is ordered based on the order of function call execution during application code start-up. In some examples, such software tools (e.g., compilers, linkers, etc.) can implement a smart layout algorithm using static call graph and dynamic code coverage to arrange the program code in function call order, thereby improving the internal memory “hit” ratio by causing content mirroring to follow the function call order of the program code. For these reasons, a smart layout algorithm may increase boot speed of an electronic device by allowing for faster code execution before the image transfer is complete, thereby reducing boot time for the electronic device.

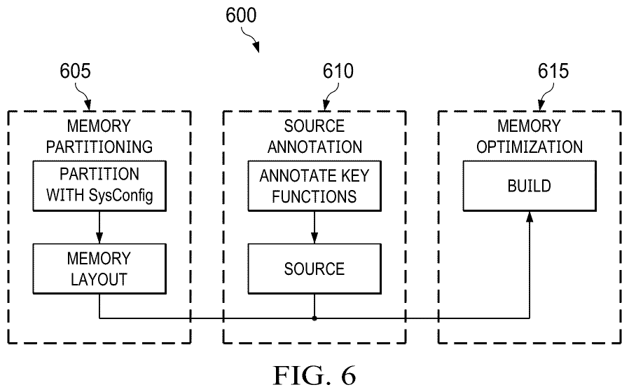

FIGS. 6-8 are flowcharts representative of example software tool operations that generate program content layouts in off-chip memory and the associated configuration information to be used by the example mirror accelerator circuit(s) 202 of FIGS. 2-5 to perform intelligent movement of external content (e.g., code and data) from the off-chip memory to internal memory. For example, FIG. 6 is a flowchart representative of example machine-readable instructions and/or example operations 600 that may be at least one of executed, instantiated, or performed by programmable circuitry to perform code annotation and building using example software tools disclosed herein. The example machine-readable instructions and/or the example operations 600 of FIG. 6 begin at block 605, at which an example system configuration tool determines a memory layout for the system 208, which includes the MCU 200 and off-chip memory 205.

At block 610, an example compiler tool annotates and compiles the program code for an application to be stored in the off-chip memory 205. In some examples, the compiler tool annotates particular program code functions that are to be mirrored from the off-chip memory 205 to the internal memory (e.g., the shared memory 235 and/or the local memory 220) of the system 208. In some examples, the annotations are based on an attribute (also referred to as a keyword) that are applied by the software compiler to function definitions and/or declarations automatically and/or based on user input. In some examples, the annotations can be applied to global functions and local functions.

Example syntax for an annotation applied to source code by the example software compiler is illustrated in Table 1.

TABLE 1

_attribute_((fast_local_copy(flcregionid)))

Example syntax used by the example software compiler to apply the annotation of Table 1 to an example function func3( ) is shown in Table 2.

TABLE 2

_attribute_((fast_local_copy(1))) void func3(void) { .. } //
Place in FLC Region 1

In Tables 1 and 2, the keyword “fast_local_copy” indicates the program code associated with the function func3( ) is to be mirrored from the off-chip memory 205 to the internal memory (e.g., the shared memory 235 and/or the local memory 220) of the system 208. In Tables 1 and 2, the variable “flcregionid” is used to define different possible regions into which program code functions annotated with the keyword “fast_local_copy” are to be grouped in the off-chip memory 205.

Example syntax for an annotation applied to assembly code by the example software compiler is illustrated in Table 2.

TABLE 3

global <global function symbol>
.sym_meta_info <global function symbol>, “of_placement”,
“fast_local_copy”, <regionid>

At block 615, an example software linker builds the compiled program code from block 610 based on the memory layout determined at block 605 to determine the program content (e.g., the program image, such as code, data, etc.) to be stored in the off-chip memory 205 for the application. In some examples, the software linker uses the attributes to collect function input sections into documented output sections corresponding to regions identified by the region variable flcregionid. Example section names corresponding respectively to different values of the region variable flcregionid are provided in Table 4.

TABLE 4

.TI.flc.region1 // Corresponding to code designated
for region flcregionid = 1.
.TI.flc.region2 // Corresponding to code designated
for region flcregionid = 2.
.TI.flc.region3 // Corresponding to code designated
for region flcregionid = 3.
.TI.flc.region4 // Corresponding to code designated
for region flcregionid = 4.

In some examples, at block 615, the software linker sorts the input sections based on linear execution order as provided by a call graph, such as a static function dependency call graph that identifies the functions that can be invoked during boot-up. Also, at block 615, the software linker aggregates the sorted input sections into region-specific output sections.

In some examples, at block 615, the linker software places output sections in off-chip memory as designated by a linker command file. An example linker command file is provided in Table 5

TABLE 5

```
SECTIONS
{
  .TI.flc.region1 : { } > FLASH
  .TI.flc.region2 : { } > FLASH
  .Tl.flc.region3 : { } > FLASH
  .TI.flc.region4 : { } > FLASH
}
```

In some examples, at block 615, the software linker automatically generates the corresponding start/stop symbols that can be used to program the FLC (or intelligent mirror) regions. Example of such symbols are provided in Table 6.

TABLE 6

_start_TI_flc_region1,_stop_TI_flc_region1
_start_TI_flc_region2,_stop_TI_flc_region2
_start_Tl_flc_region3,_stop_TI_flc_region3
_start_TI_flc_region4,_stop_TI_flc_region4

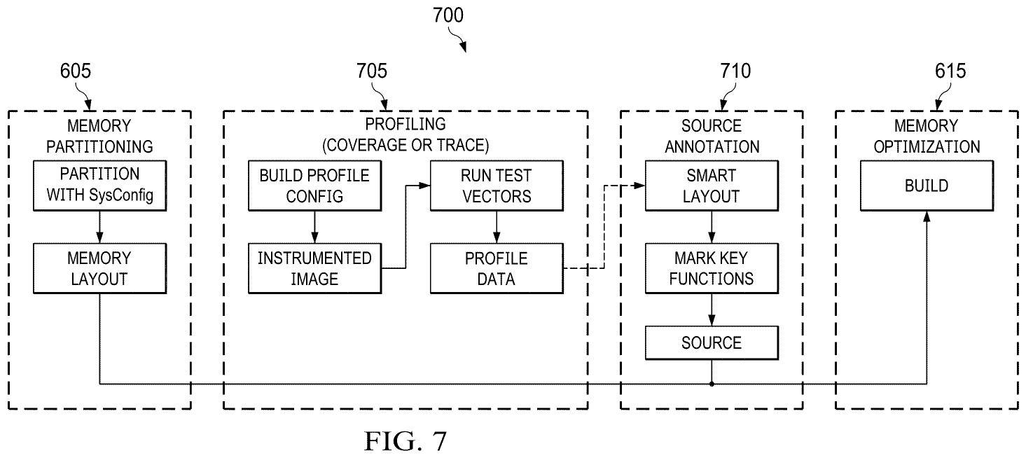

FIG. 7 is another flowchart representative of example machine-readable instructions and/or example operations 700 that may be at least one of executed, instantiated, or performed by programmable circuitry to perform code annotation and building using example software tools disclosed herein. The example machine-readable instructions and/or the example operations 700 of FIG. 7 include blocks 605 and 615 of the example machine-readable instructions and/or the example operations 600 of FIG. 6, which are described above. However, the example machine-readable instructions and/or the example operations 700 also include blocks 705 and 710. At block 705, an example software profiler generates profile data for the program code and data to be stored in the off-chip memory 205. At block 710, the compiler tool performs a smart layout algorithm based on the profile data before proceeding to annotating and compiling the program code, as described above in connection with block 610 of FIG. 6.

The example machine-readable instructions and/or the example operations 700 include the software profiler operations at block 705 and the smart layout algorithm of block 710 with a goal reducing CPU transaction misses to the off-chip memory 205 (e.g., the Flash memory) due to the mirroring operations to internal memory (e.g., the shared memory 235 and/or the local memory 220) having not completed. In some examples, at block 705, the software profiler supports the goal by generating (e.g., using trace and/or debugger tools) profile data based on execution of an instrumented image of the program code with one more test vectors. At block 710, the resulting profile data can be used by a compiler or other layout tool to perform the smart layout of code such that code functions are mirrored in the order in which they are executed during boot-up, and/or based on frequency of execution. By giving the DMA copy a head start (e.g., of a few kilobytes), the program code has higher probability of already being copied to RAM when it is executed by the CPU 210, thus reducing CPU transaction misses to the off-chip memory 205 (e.g., the Flash memory). Also in the event there is an asynchronous event, such as an interrupt or error handling operation that is not in the boot code sequence, then system 208 will still function as expected by directing the CPU transaction to going to off-chip memory 205 (e.g., corresponding to the transition from block 520 to block 525 of FIG. 5).

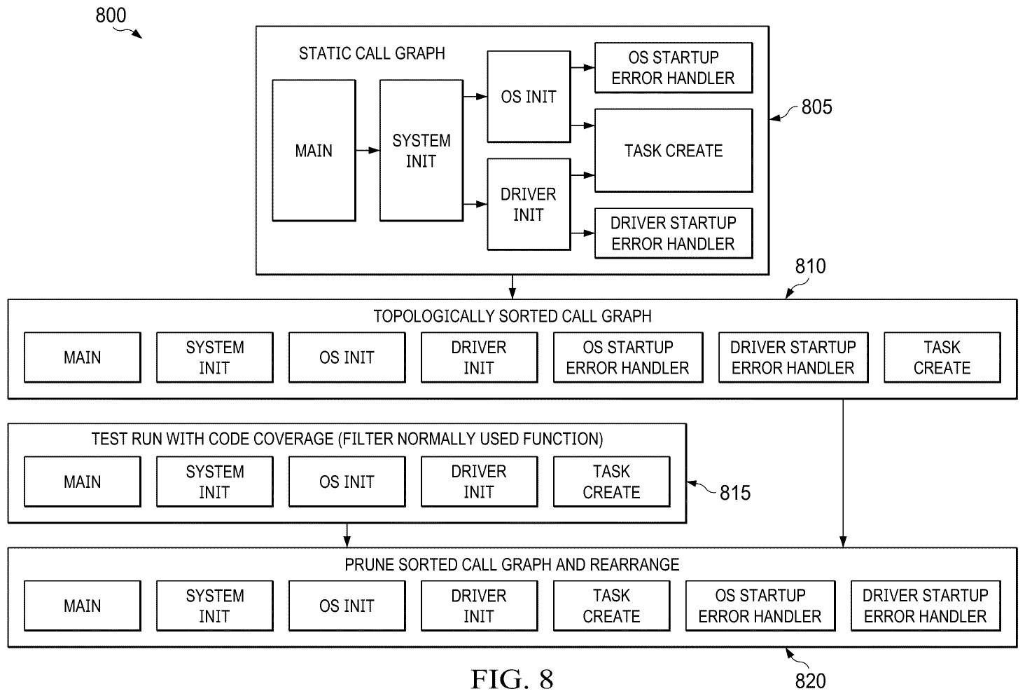

FIG. 8 is a flowchart representative of example machine-readable instructions and/or example operations 800 that may be used to implement the operations at blocks 705 and 710 of FIG. 7. The example machine-readable instructions and/or the example operations 800 of FIG. 8 begin at block 805, at which the software linker generates a static function dependency call graph for the application program code being built. At block 810, the compiler or other layout tool performs a topological sort of the call graph based on profile data provided by the profiler tool described above, which yields the order of execution of the functions, the frequence of execution of the functions, etc., or any combination thereof. However not all functions are actually executed during system startup. For example, some functions may be error handlers, conditional interrupt routines, etc., that are infrequently executed. Thus, at block 815, the compiler or other layout tool uses the profiler data to identify those functions that are executed in a normal startup sequence (as well as their frequency of execution, in some examples). Then, at block 820, the compiler or other layout tool performs a smart layout algorithm, such as a dynamic code convergence analysis, to prune the topological sorted call graph based on actual function usage/invocation to place functions that are executed in a normal startup sequence at the beginning of the pruned graph and places the remaining infrequently executed functions at the end of the graph. Additionally or alternatively, in some examples, at block 820, the compiler or other layout tool prunes the topological sorted call graph to place functions in the pruned graph based on their execution frequency (e.g., with more frequently executed functions placed nearer to the beginning of the pruned graph.) In some such examples, at block 820, the compiler or other layout tool also identifies a target internal memory in which to place a given function based on its execution frequency, such as placing more frequently executed functions in faster memory, such as TCM. The software compiler and software linker then perform the remaining operations of blocks 610 and 615 described above using the pruned graph from block 820 to place the application program code in the off-chip memory 205 in an order based on the pruned call graph.

With the foregoing in mind, some example software tools disclosed herein are embodied in at least one non-transitory computer-readable medium including computer readable instructions to cause at least one processor circuit (e.g., such as the example programmable circuitry 1112, which is described in further detail below) to at least aggregate input sections of program code into output sections based on annotations associated with the input sections of the program code. In some examples, the annotations include region identifiers to identify regions of an off-chip memory. In some examples, the instructions of the software tools also cause one or more of the at least one processor circuit to place the output sections into respective regions of the off-chip memory based on the region identifiers.

In some examples, the computer readable instructions that implement the software tools also cause one or more of the at least one processor circuit to order the input sections of the program code based on a call graph.

In some examples, the computer readable instructions that implement the software tools also cause one or more of the at least one processor circuit to add the annotations to the ordered input sections of the program code.

In some examples, the annotations include a keyword to indicate the input sections of the program code are to be copied from the off-chip memory to internal memory of a device.

In some examples, the computer readable instructions that implement the software tools also cause one or more of the at least one processor circuit to profile the program code based on test data to determine profile data, and order the input sections of the program code based on the profile data. In some examples, the computer readable instructions that implement the software tools also cause one or more of the at least one processor circuit to order program data based on access patterns to cause the program data that is accessed more frequently to be copied to faster memory (e.g., such as a TCM).

In some examples, the computer readable instructions that implement the software tools also cause one or more of the at least one processor circuit to add the annotations to the ordered input sections of the program code.

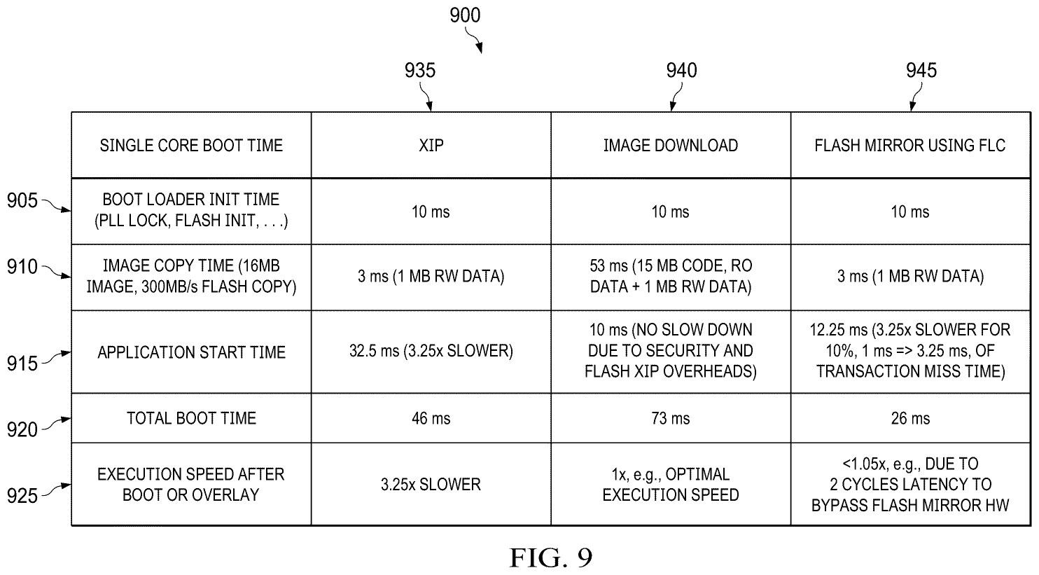

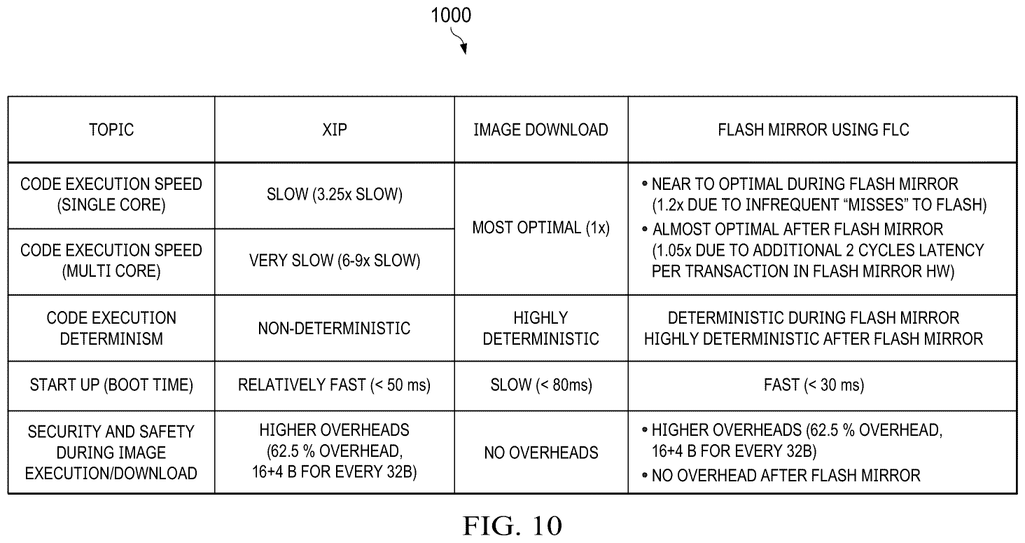

FIGS. 9-10 illustrate example performance results capable of being achieved by the mirror accelerator circuit(s) 202 included in the example microcontroller unit 200 of FIG. 2. FIG. 9 illustrates example performance results 900 that include example boot loader initialization times 905, image copy times 910, application start times 915, overall boot times 920 and application execution speeds 925 associated with the intelligent external content mirroring techniques 930 disclosed herein, as compared to the XIP approach 935 and the image download approach 940. As can be seen from FIG. 9, the intelligent external content mirroring techniques 930 can achieve an overall boot time 920 that meets the 30 ms target while yielding an application execution speed 925 on par with execution from internal memory. FIG. 10 illustrates similar example performance results 1000.

The preceding examples have described intelligent content mirroring techniques that are based on an example mirror accelerator circuit that intelligently mirrors content from external (e.g., off-chip) memory to internal memory. However, the intelligent content mirroring techniques are not limited to such examples. On the contrary, the intelligent content mirroring techniques can be applied in other contexts.

For example, the mirror accelerator circuit described herein can be adapted to move (e.g., mirror) code and/or data from slower internal memory (e.g., an L2 RAM) to faster internal memory (e.g., a TCM) in the context of run-time and/or dynamic overlay management. Using a mirror accelerator circuit, as described herein, to perform such internal content mirroring can yield performance improvement with minimal overhead as the application or CPU utilizing the code and/or data being mirrored would not need to check for DMA completion before accessing the code and/or data. Rather, the mirror accelerator circuit would automatically direct the code/data transaction to the appropriate faster or slower internal memory depending on whether the DMA mirroring of that code/data has completed.

As another example, the mirror accelerator circuit described herein can be adapted to support data overlay applications that swap different blocks of code and/or data from Flash memory to main memory. Using a mirror accelerator circuit, as described herein, to perform such data swapping can reduce Flash read accesses, thereby improving system reliability and reducing power consumption.

As yet another example, the mirror accelerator circuit described herein can be adapted to support over-the-air (OTA) updates, such as firmware OTA (FOTA) updates. For example, an FOTA update can cause a firmware update (e.g., code and/or data) to be received and stored in an external Flash memory. The mirror accelerator circuit described herein can be used to mirror the firmware update from the external Flash memory to an internal or on-chip Flash memory (or other Flash memory) to provide the storage redundancy utilized by the FOTA procedure.

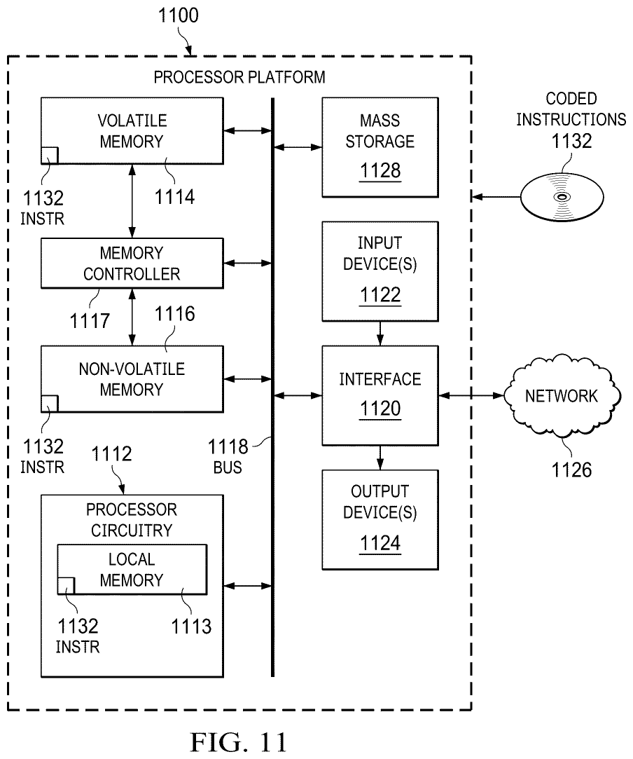

FIG. 11 is a block diagram of an example programmable circuitry platform 1100 structured to one or a combination of execute or instantiate one or more of the example machine-readable instructions or the example operations of FIGS. 6-8 to implement the example software tools disclosed herein to support intelligent movement of external content from external (e.g., off-chip) memory to internal memory. The programmable circuitry platform 1100 can be, for example, a server, a personal computer, a workstation, a self-learning machine (e.g., a neural network), a mobile device (e.g., a cell phone, a smart phone, a tablet such as an iPad™), or any other type of computing or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, or microcontrollers from any desired family or manufacturer. The programmable circuitry 1112 may be implemented by one or more semiconductor based (e.g., silicon based) devices.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 1116 may be implemented by one or a combination of flash memory or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 1122 are connected to the interface circuitry 1120. The input device(s) 1122 permit(s) a user (e.g., a human user, a machine user, etc.) to enter one of or a combination of data or commands into the programmable circuitry 1112. The input device(s) 1122 can be implemented by, for example, one of or a combination of an audio sensor, a microphone, a camera (still or video), a keyboard, a button, a mouse, a touchscreen, a trackpad, a trackball, an isopoint device, or a voice recognition system.

One or more output devices 1124 are also connected to the interface circuitry 1120 of the illustrated example. The output device(s) 1124 can be implemented, for example, by one of or a combination of display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 1120 of the illustrated example, thus, includes one of or a combination of a graphics driver card, a graphics driver chip, or graphics processor circuitry such as a GPU.

The interface circuitry 1120 of the illustrated example also includes a communication device such as one of or a combination of a transmitter, a receiver, a transceiver, a modem, a residential gateway, a wireless access point, or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store one or more of firmware, software, or data. Examples of such mass storage discs or devices 1128 include one or more magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices and SSDs.

The machine-readable instructions 1132, which may be implemented by the machine-readable instructions of FIGS. 6-8, may be stored in one of or a combination of the mass storage device 1128, in the volatile memory 1114, in the non-volatile memory 1116, or on at least one non-transitory computer readable storage medium such as a CD or DVD which may be removable.

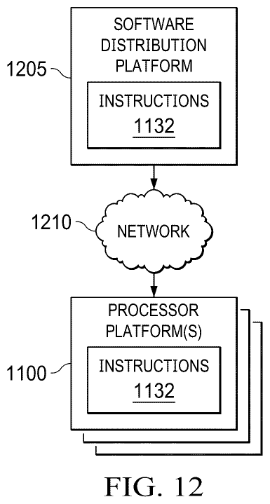

A block diagram illustrating an example software distribution platform 1205 to distribute software such as the example machine-readable instructions 1132 of FIG. 11 to other hardware devices (e.g., one or more hardware devices owned or operated by third parties from the owner or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity at least one of owning or operating the software distribution platform 1205. For example, the entity that at least one of owns or operates the software distribution platform 1205 may be at least one of a developer, a seller, or a licensor of software such as the example machine-readable instructions 1132 of FIG. 11. The third parties may be consumers, users, retailers, OEMs, etc., who one of or a combination of purchase or license the software for at least one of use, re-sale, or sub-licensing. In the illustrated example, the software distribution platform 1205 includes one or more servers and one or more storage devices. The storage devices store the machine-readable instructions 1132, which may correspond to the example machine-readable instructions of FIGS. 6-8, as described above. The one or more servers of the example software distribution platform 1205 are in communication with an example network 1210, which may correspond to any one or more of the Internet or any of the example networks described above. In some examples, the one or more servers are responsive to requests to transmit the software to a requesting party as part of a commercial transaction. Payment for the delivery, sale, and/or license of the software may be handled by the one or more servers of the software distribution platform, and/or by a third party payment entity. The servers enable one or more purchasers or licensors to download the machine-readable instructions 1132 from the software distribution platform 1205. For example, the software, which may correspond to the example machine-readable instructions of FIG. 6-8, may be downloaded to the example programmable circuitry platform 1100, which is to execute the machine-readable instructions 1132 to implement the example software tools disclosed herein. In some examples, one or more servers of the software distribution platform 1205 periodically at least one of offer, transmit, or force updates to the software (e.g., the example machine-readable instructions 1132 of FIG. 11) to ensure improvements, patches, updates, etc., are distributed and applied to the software at the end user devices. Although referred to as software above, the distributed “software” could alternatively be firmware.

While an example manner of implementing the system 208 is illustrated in FIGS. 2-5, one or more of the elements, processes, or devices illustrated in FIGS. 2-5 may be combined, divided, re-arranged, omitted, eliminated, or implemented in any other way. Further, the example MCU 200, the example mirror accelerator circuit(s) 202, the example off-chip memory 205, the example CPU(s) 210, the example processor core(s) 215, the example local memory 220, the example instruction cache(s) 225, the example data cache(s) 230, the example shared memory 235, the example memory controller circuitry 240, the example interconnect circuitry 245, the example DMA circuit 405, the example transaction decoder circuit 410, or, more generally, the example system 208, may be implemented by hardware alone or by hardware in combination with software and firmware. Thus, for example, any of the example MCU 200, the example mirror accelerator circuit(s) 202, the example off-chip memory 205, the example CPU(s) 210, the example processor core(s) 215, the example local memory 220, the example instruction cache(s) 225, the example data cache(s) 230, the example shared memory 235, the example memory controller circuitry 240, the example interconnect circuitry 245, the example DMA circuit 405, the example transaction decoder circuit 410, or, more generally, the example system 208, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example system 208 may include one or more elements, processes, or devices in addition to, or instead of, those illustrated in FIGS. 2-5, or may include more than one of any or all of the illustrated elements, processes and devices.

Flowchart(s) representative of example machine-readable instructions, which may be executed by programmable circuitry to at least one of implement or instantiate the example software tools described herein to perform code annotation and building or representative of example operations which may be performed by programmable circuitry to at least one of implement or instantiate the example software tools described herein to perform code annotation and building, are shown in FIGS. 6-8. The machine-readable instructions may be one or more executable programs or portion(s) of one or more executable programs for execution by programmable circuitry such as the programmable circuitry 1112 shown in the example processor platform 1100 discussed below in connection with FIG. 11. In some examples, the machine-readable instructions cause an operation, a task, etc., to be carried out or performed in an automated manner in the real-world. As used herein, “automated” means without human involvement.

The program may be embodied in instructions (e.g., software and/or firmware) stored on one or more non-transitory computer readable and/or machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of the non-transitory computer readable and/or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 6-8, many other methods of implementing the example software tools disclosed herein may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (e.g., processor circuitry, discrete, integrated analog and/or digital circuitry, an FPGA, an ASIC, etc. structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). For example, the programmable circuitry may be one of or a combination of a CPU or an FPGA located in the same package (e.g., the same integrated circuit (IC) package or in two or more separate housings), one or more processors in a single machine, multiple processors distributed across multiple servers of a server rack, multiple processors distributed across one or more server racks, etc., or any combination(s) thereof.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine executable instructions. For example, the machine-readable instructions may be fragmented and stored on one or more storage devices, disks or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, or executable by a computing device or other machine. For example, the machine-readable instructions may be stored in multiple parts, which are individually compressed, encrypted, or stored on separate computing devices, wherein the parts when decrypted, decompressed, or combined form a set of one or more computer-executable or machine executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer readable or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6-8 may be implemented using executable instructions (e.g., computer readable and/or machine-readable instructions) stored on one or more non-transitory computer readable or machine-readable media. As used herein, the terms non-transitory computer readable medium, non-transitory computer readable storage medium, non-transitory machine-readable medium, and non-transitory machine-readable storage medium are expressly defined to include any type of computer readable storage device or storage disk and to exclude propagating signals and to exclude transmission media. Examples of such non-transitory computer readable medium, non-transitory computer readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer readable instructions, machine-readable instructions, etc., or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Notwithstanding the foregoing, in the case of referencing at least one of a semiconductor device (e.g., a transistor), a semiconductor die containing a semiconductor device, or an integrated circuit (IC) package containing a semiconductor die during fabrication or manufacturing, “above” is not with reference to Earth, but instead is with reference to an underlying substrate on which relevant components are fabricated, assembled, mounted, supported, or otherwise provided. Thus, as used herein and unless otherwise stated or implied from the context, a first component within a semiconductor die (e.g., a transistor or other semiconductor device) is “above” a second component within the semiconductor die when the first component is farther away from a substrate (e.g., a semiconductor wafer) during fabrication/manufacturing than the second component on which the two components are fabricated or otherwise provided. Similarly, unless otherwise stated or implied from the context, a first component within an IC package (e.g., a semiconductor die) is “above” a second component within the IC package during fabrication when the first component is farther away from a printed circuit board (PCB) to which the IC package is to be mounted or attached. Semiconductor devices are often used in orientation different than their orientation during fabrication. Thus, when referring to one of or a combination of a semiconductor device (e.g., a transistor), a semiconductor die containing a semiconductor device, or an integrated circuit (IC) package containing a semiconductor die during use, the definition of “above” in the preceding paragraph (i.e., the term “above” describes the relationship of two parts relative to Earth) will likely govern based on the usage context.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by at least one of the connection reference or relative movement between those elements unless otherwise indicated. As such, connection references do not necessarily infer that two elements are directly connected or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to at least one of manufacturing tolerances or other real-world imperfections. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., at least one of programmed or hardwired) at a time of manufacturing by a manufacturer to at least one of perform the function or be configurable (or re-configurable) by a user after manufacturing to perform the function/or other additional or alternative functions. The configuring may be through at least one of firmware or software programming of the device, through at least one of a construction or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as voltage and/or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Uses of the phrase “ground” in the foregoing description include at least one of a chassis ground, an Earth ground, a floating ground, a virtual ground, a digital ground, a common ground, or any other form of ground connection applicable to, or suitable for, the teachings of this description. Unless otherwise stated, “about,” “approximately,” or “substantially” preceding a value means+/−10 percent of the stated value, or, if the value is zero, a reasonable range of values around zero.

Modifications are possible in the described embodiments, and other embodiments are possible, within the scope of the claims.

From the foregoing, it will be appreciated that example systems, apparatus, articles of manufacture, and methods have been described that implement intelligent movement of external content from off-chip memory to internal memory. Described systems, apparatus, articles of manufacture, and methods improve the efficiency of a computing device by mirroring application program content from off-chip memory to internal memory that allows program execution to begin almost immediately without waiting for mirror operations to complete. Such intelligent content mirroring reduces overall boot time for devices that have application program code and data stored in off-chip memory while achieving application execution speed on par with execution from internal memory. Furthermore, such intelligent content mirroring supports execution of program code in-place from off-chip memory in the event that mirroring of that program code has not completed. Described systems, apparatus, articles of manufacture, and methods are also directed to one or more improvement(s) in the operation of a machine such as a computer or other electronic, electromechanical, or mechanical device.

Further examples and combinations thereof include the following. Example 1 includes an accelerator circuit comprising a direct memory access (DMA) circuit configured to copy contents of an off-chip memory to an internal memory of a device, the off-chip memory external to the device, and a decoder circuit configured to determine a transaction from a processor circuit of the device is associated with a memory address included in a region of the off-chip memory to be copied to the internal memory, and direct the transaction to one of the off-chip memory or the internal memory based on whether a DMA copy of the region of the off-chip memory to the internal memory has completed.

Example 2 includes the accelerator circuit of example 1, wherein the DMA circuit is configured to copy the region of the off-chip memory to the internal memory based on configuration information provided by a bootloader stored in the off-chip memory, wherein the configuration information to specify a start address of the region of the off-chip memory and at least one of an end address of the region of the off-chip memory, or a size of the region of the off-chip memory.

Example 3 includes the accelerator circuit of example 2, wherein the configuration information is to specify a start address of the internal memory to which the region of the off-chip memory is to be copied.

Example 4 includes the accelerator circuit of example 2, wherein the region is one of a plurality of regions of the off-chip memory to be copied to the internal memory, the configuration information is to specify at least one of (i) respective start addresses and end addresses of the regions of the off-chip memory, or (ii) the respective start addresses and respective sizes of the regions of the off-chip memory, and execution of the bootloader by the processor circuit is to cause the DMA circuit to initiate copying of the regions of the off-chip memory to the internal memory based on the configuration information, and cause the processor circuit to initiate execution of an application associated with the contents of the regions of the off-chip memory before the copying of the regions of the off-chip memory to the internal memory has completed.

Example 5 includes the accelerator circuit of any one of examples 1 to 4, wherein the decoder circuit is configured to direct the transaction to the internal memory after a determination that the DMA copy of the region of the off-chip memory to the internal memory has completed, and direct the transaction to the off-chip memory after a determination that the DMA copy of the region of the off-chip memory to the internal memory has not completed.

Example 6 includes the accelerator circuit of example 5, wherein the decoder circuit is configured to perform an address translation on the transaction before directing the transaction to the internal memory.

Example 7 includes the accelerator circuit of example 5 or example 6, wherein the decoder circuit is configured to perform an address translation on the transaction before directing the transaction to the off-chip memory.

Example 8 includes a device comprising internal memory, a processor circuit, and an accelerator circuit configured to initiate a copy of a region of an off-chip memory to the internal memory based on configuration information provided by a bootloader, the bootloader stored in the off-chip memory, determine a transaction from the processor circuit is associated with a memory address included in the region of the off-chip memory, and direct the transaction to one of the off-chip memory or the internal memory based on whether the copy of the region of the off-chip memory to the internal memory has completed.

Example 9 includes the device of example 8, wherein the processor circuit is a first processor circuit, the accelerator circuit is a first accelerator circuit, the region of the off-chip memory is a first region, the configuration information is first configuration information, and including a second processor circuit, and a second accelerator circuit configured to initiate a copy of a second region of the off-chip memory to the internal memory based on second configuration information provided by the bootloader, determine a transaction from the second processor circuit is associated with a memory address included in the second region of the off-chip memory, and direct the transaction to one of the off-chip memory or the internal memory based on whether the copy of the second region of the off-chip memory to the internal memory has completed.

Example 10 includes the device of example 8, wherein the processor circuit is a first processor circuit, the accelerator circuit is a first accelerator circuit, the internal memory is first internal memory, the region of the off-chip memory is a first region, the configuration information is first configuration information, and including second internal memory, a second processor circuit, and a second accelerator circuit configured to initiate a copy of a second region of the off-chip memory to the second internal memory based on second configuration information provided by the bootloader, determine a transaction from the second processor circuit is associated with a memory address included in the second region of the off-chip memory, and direct the transaction to one of the off-chip memory or the second internal memory based on whether the copy of the second region of the off-chip memory to the second internal memory has completed.

Example 11 includes the device of example 10, wherein the first internal memory includes a first tightly coupled memory associated with the first processor circuit, and the second internal memory includes a second tightly coupled memory associated with the second processor circuit.

Example 12 includes the device of any one of examples 8 to 11, wherein the accelerator circuit is configured to cause at least one of authentication or error correction to be performed on contents of the region of the off-chip memory copied to the internal memory.

Example 13 includes the device of any one of examples 8 to 11, wherein the accelerator circuit is configured to direct the transaction to the internal memory after a determination that the copy of the region of the off-chip memory to the internal memory has completed, and direct the transaction to the off-chip memory after a determination that the copy of the region of the off-chip memory to the internal memory has not completed.

Example 14 includes the device of example 13, wherein the accelerator circuit is configured to perform an address translation on the transaction before directing the transaction to the internal memory.

Example 15 includes a system comprising random access memory, a processor circuit, off-chip memory external to the processor circuit, and an accelerator circuit configured to copy one or more regions of the off-chip memory to the random access memory based on configuration information provided by a bootloader, determine a transaction from the processor circuit is associated with a memory address included in a first one of the regions of the off-chip memory to be copied to the random access memory, and direct the transaction to one of the off-chip memory or the random access memory based on whether the copy of the first one of the regions of the off-chip memory to the random access memory has completed.

Example 16 includes the system of example 15, wherein the bootloader is stored in the off-chip memory.

Example 17 includes the system of example 15 or example 16, wherein the processor circuit is a first processor circuit, the one or more regions of the off-chip memory are one or more first regions associated with the first processor circuit, and the off-chip memory includes one or more second regions associated with a second processor circuit.

Example 18 includes the system of example 17, wherein the random access memory is first random access memory, the accelerator circuit is a first accelerator circuit, the configuration information is first configuration information, and including second random access memory, the second processor circuit, and a second accelerator circuit configured to copy the one or more second regions of the off-chip memory to one of the first random access memory or the second random access memory based on second configuration information provided by the bootloader, determine a transaction from the second processor circuit is associated with a memory address included in a first one of the second regions of the off-chip memory to be copied to the one of the first random access memory or the second random access memory, and direct the transaction to one of the off-chip memory or the one of the first random access memory or the second random access memory based on whether the copy of the first one of the second regions of the off-chip memory to the one of the first random access memory or the second random access memory has completed.

Example 19 includes the system of any one of examples 15 to 18, wherein the accelerator circuit is configured to perform an address translation on the transaction before directing the transaction to the random access memory.

Example 20 includes the system of any one of examples 15 to 19, wherein the accelerator circuit is configured to perform an address translation on the transaction before directing the transaction to the off-chip memory.

Example 21 includes the system of example 15, further including a non-transitory computer-readable medium comprising computer readable instructions to cause a compute device to at least profile program code based on test data to determine profile data, determine a call graph based on the program code and the profile data, order input sections of the program code based on a call graph, aggregate the input sections of program code into output sections based on annotations associated with the input sections of the program code, the annotations including region identifiers to identify the first regions and the second regions of the off-chip memory, and place the output sections into the first regions and the second regions of the off-chip memory based on the region identifiers.

Example 22 includes the system of example 21, wherein the call graph is a second call graph, and the instructions are to cause the compute device to determine a first call graph based on the program code, and prune the first call graph based on the profile data to determine the second call graph.

Example 23 includes the system of example 22, wherein the instructions are to cause the compute device to prune the first call graph based on at least one function execution order or function execution frequency specified in the profile data.

Example 24 includes a non-transitory computer-readable medium comprising computer readable instructions to cause at least one processor circuit to at least aggregate input sections of program code into output sections based on annotations associated with the input sections of the program code, the annotations including region identifiers to identify regions of an off-chip memory, and place the output sections into respective regions of the off-chip memory based on the region identifiers.

Example 25 includes the non-transitory computer-readable medium of example 24, wherein the computer readable instructions are to cause one or more of the at least one processor circuit to order the input sections of the program code based on a call graph.

Example 26 includes the non-transitory computer-readable medium of example 25, wherein the computer readable instructions are to cause one or more of the at least one processor circuit to add the annotations to the ordered input sections of the program code.

Example 27 includes the non-transitory computer-readable medium of any one of examples 24 to 26, wherein the annotations include a keyword to indicate the input sections of the program code are to be copied from the off-chip memory to internal memory of a device.

Example 28 includes the non-transitory computer-readable medium of any one of examples 24 to 27, wherein the computer readable instructions are to cause one or more of the at least one processor circuit to profile the program code based on test data to determine profile data, and order the input sections of the program code based on the profile data.

Example 29 includes the non-transitory computer-readable medium of example 28, wherein the computer readable instructions are to cause one or more of the at least one processor circuit to add the annotations to the ordered input sections of the program code.

The following claims are hereby incorporated into this Detailed Description by this reference. Although certain example systems, apparatus, articles of manufacture, and methods have been described herein, the scope of coverage of this patent is not limited thereto. On the contrary, this patent covers all systems, apparatus, articles of manufacture, and methods fairly falling within the scope of the claims of this patent.

What is claimed is:

1. An accelerator circuit comprising:
a direct memory access (DMA) circuit configured to copy contents of an off-chip memory to an internal memory of a device, the off-chip memory external to the device; and
a decoder circuit configured to:
determine a transaction from a processor circuit of the device is associated with a memory address included in a region of the off-chip memory to be copied to the internal memory; and
direct the transaction to one of the off-chip memory or the internal memory based on whether a DMA copy of the region of the off-chip memory to the internal memory has completed.

2. The accelerator circuit of claim 1,
wherein the DMA circuit is configured to copy the region of the off-chip memory to the internal memory based on configuration information provided by a bootloader stored in the off-chip memory,
wherein the configuration information to specify a start address of the region of the off-chip memory and at least one of:
an end address of the region of the off-chip memory, or
a size of the region of the off-chip memory.

3. The accelerator circuit of claim 2, wherein the configuration information is to specify a start address of the internal memory to which the region of the off-chip memory is to be copied.

4. The accelerator circuit of claim 2, wherein the region is one of a plurality of regions of the off-chip memory to be copied to the internal memory, the configuration information is to specify at least one of (i) respective start addresses and end addresses of the regions of the off-chip memory, or (ii) the respective start addresses and respective sizes of the regions of the off-chip memory, and execution of the bootloader by the processor circuit is to:
cause the DMA circuit to initiate copying of the regions of the off-chip memory to the internal memory based on the configuration information; and
cause the processor circuit to initiate execution of an application associated with the contents of the regions of the off-chip memory before the copying of the regions of the off-chip memory to the internal memory has completed.

5. The accelerator circuit of claim 1, wherein the decoder circuit is configured to:
direct the transaction to the internal memory after a determination that the DMA copy of the region of the off-chip memory to the internal memory has completed; and
direct the transaction to the off-chip memory after a determination that the DMA copy of the region of the off-chip memory to the internal memory has not completed.

6. The accelerator circuit of claim 5, wherein the decoder circuit is configured to perform an address translation on the transaction before directing the transaction to the internal memory.

7. The accelerator circuit of claim 5, wherein the decoder circuit is configured to perform an address translation on the transaction before directing the transaction to the off-chip memory.

8. A device comprising:
internal memory;
a processor circuit; and
an accelerator circuit configured to:
initiate a copy of a region of an off-chip memory to the internal memory based on configuration information provided by a bootloader, the bootloader stored in the off-chip memory;
determine a transaction from the processor circuit is associated with a memory address included in the region of the off-chip memory; and
direct the transaction to one of the off-chip memory or the internal memory based on whether the copy of the region of the off-chip memory to the internal memory has completed.

9. The device of claim 8, wherein the processor circuit is a first processor circuit, the accelerator circuit is a first accelerator circuit, the region of the off-chip memory is a first region, the configuration information is first configuration information, and including:
a second processor circuit; and
a second accelerator circuit configured to:
initiate a copy of a second region of the off-chip memory to the internal memory based on second configuration information provided by the bootloader;
determine a transaction from the second processor circuit is associated with a memory address included in the second region of the off-chip memory; and
direct the transaction to one of the off-chip memory or the internal memory based on whether the copy of the second region of the off-chip memory to the internal memory has completed.

10. The device of claim 8, wherein the processor circuit is a first processor circuit, the accelerator circuit is a first accelerator circuit, the internal memory is first internal memory, the region of the off-chip memory is a first region, the configuration information is first configuration information, and including:
second internal memory;
a second processor circuit; and
a second accelerator circuit configured to:
initiate a copy of a second region of the off-chip memory to the second internal memory based on second configuration information provided by the bootloader;
determine a transaction from the second processor circuit is associated with a memory address included in the second region of the off-chip memory; and
direct the transaction to one of the off-chip memory or the second internal memory based on whether the copy of the second region of the off-chip memory to the second internal memory has completed.

11. The device of claim 10, wherein the first internal memory includes a first tightly coupled memory associated with the first processor circuit, and the second internal memory includes a second tightly coupled memory associated with the second processor circuit.

12. The device of claim 8, wherein the accelerator circuit is configured to cause at least one of authentication or error correction to be performed on contents of the region of the off-chip memory copied to the internal memory.

13. The device of claim 8, wherein the accelerator circuit is configured to:
direct the transaction to the internal memory after a determination that the copy of the region of the off-chip memory to the internal memory has completed; and
direct the transaction to the off-chip memory after a determination that the copy of the region of the off-chip memory to the internal memory has not completed.

14. The device of claim 13, wherein the accelerator circuit is configured to perform an address translation on the transaction before directing the transaction to the internal memory.

15. A system comprising:
random access memory;
a processor circuit;
off-chip memory external to the processor circuit; and
an accelerator circuit configured to:
copy one or more regions of the off-chip memory to the random access memory based on configuration information provided by a bootloader;
determine a transaction from the processor circuit is associated with a memory address included in a first one of the regions of the off-chip memory to be copied to the random access memory; and
direct the transaction to one of the off-chip memory or the random access memory based on whether the copy of the first one of the regions of the off-chip memory to the random access memory has completed.

16. The system of claim 15, wherein the processor circuit is a first processor circuit, the one or more regions of the off-chip memory are one or more first regions associated with the first processor circuit, and the off-chip memory includes one or more second regions associated with a second processor circuit.

17. The system of claim 16, wherein the random access memory is first random access memory, the accelerator circuit is a first accelerator circuit, the configuration information is first configuration information, and including:
second random access memory;
the second processor circuit; and
a second accelerator circuit configured to:
copy the one or more second regions of the off-chip memory to one of the first random access memory or the second random access memory based on second configuration information provided by the bootloader;
determine a transaction from the second processor circuit is associated with a memory address included in a first one of the second regions of the off-chip memory to be copied to the one of the first random access memory or the second random access memory; and
direct the transaction to one of the off-chip memory or the one of the first random access memory or the second random access memory based on whether the copy of the first one of the second regions of the off-chip memory to the one of the first random access memory or the second random access memory has completed.

18. The system of claim 15, further including a non-transitory computer-readable medium comprising computer readable instructions to cause a compute device to at least:
profile program code based on test data to determine profile data;
determine a call graph based on the program code and the profile data;
order input sections of the program code based on a call graph;
aggregate the input sections of program code into output sections based on annotations associated with the input sections of the program code, the annotations including region identifiers to identify the regions of the off-chip memory; and
place the output sections into the regions of the off-chip memory based on the region identifiers.

19. The system of claim 18, wherein the call graph is a second call graph, and the instructions are to cause the compute device to:
determine a first call graph based on the program code; and
prune the first call graph based on the profile data to determine the second call graph.

20. The system of claim 19, wherein the instructions are to cause the compute device to prune the first call graph based on at least one of function execution order or function execution frequency specified in the profile data.
